(19) United States
(12) Patent Application Publication
(10) Pub. No.: US 2008/0057160 A1
(43) Pub. Date: Mar. 6, 2008

(54) METHOD FOR FERMENTATION, EXTRACTION AND CONCENTRATION OF FRESH OF GREEN PLUM

(76) Inventor: Chung-Chuan Chang, Taipei City (TW)

Correspondence Address: CHUNG-CHUAN CHANG, 235 Chung- Ho Box 8-24, Taipei, 235, omitted

(21) Appl. No.: 11/773,965

(22) Filed: Jul. 6, 2007

(30) Foreign Application Priority Data
Aug. 30, 2006 (TW) 095132112

(51) Int. Cl. A23L 2/04

(52) U.S. Cl. 426/51

(57) ABSTRACT

A method for fermentation, extraction and condensation of flesh of green plum jam is provided. The plum jam is decomposed by natural fermentation. The flesh of plum jam and plum juicy are separated. Furthermore a method for extraction and condensation of the nutrition of green plum flesh are provided. By the method, the precious minim nutrition of the green plum can be retained in the process.

### FIELD OF THE INVENTION

The present invention relates to fermentation and extraction method of fleshes of fruits, and particularly to the fermentation, extraction and condensation of flesh of green plum jam.

### BACKGROUND OF THE INVENTION

The flesh of the plum jam is very rich, it contains the nutrition of protein, fat, carbohydrate, fiber, vitamins A, B1, B2, C, sodium, potassium, calcium, phosphorous, iron, organic acid, such as citric acid, malic acid, succinic acid, and beeswax material. Plum jam is natural organic health food, although the flavor of it tastes sour, but in fact it is alkaline food. The plum flesh is full of organic acids and has the health benefit of metabolism. Thus, the plum jam has the advantages of improving the body constitution and physical strength, enhancing immunity, preventing from illness, being against aging and prevent from cancer, reducing weight, etc. Generally, the food of people is mainly acidic. Thus if people eat more plum, it is helpful to the equilibrium of pH value in blood.

Therefore, a product of purified plum jam with a ripe rate of 60% to 70% has been sold widely. The seeds of the plums are taken out and the fleshes of the plums are compressed and boiled. In conventional processing, the trace elements of the green plum are easy to evaporate or flow away so that the nutrition is lost and the quality of the plum jam is unsteady. Furthermore the conventional treatment needs a large amount of manpower, and working hours. It is difficult by mass production and automatic processing and has the problem of sanitation.

### SUMMARY OF THE INVENTION

Accordingly, the primary object of the present invention is to provide a method for fermentation, extraction and condensation of flesh of green plum jam. The plum jam is decomposed by natural fermentation. The flesh of plum jam and plum juicy are separated. Furthermore a method for extraction and condensation of the nutrition of green plum flesh are provided. By the method, the precious minim nutrition of the green plum can be retained in the process.

### DETAILED DESCRIPTION OF THE INVENTION

In order that those skilled in the art can further understand the present invention, a description will be provided in the following in details. However, these descriptions are only used to cause those skilled in the art to understand the objects, features, and characteristics of the present invention, but not to be used to confine the scope and spirit of the present invention defined in the appended claims.

Fleshes of plum jam are provided and placed in a horizontal rolling machine with a plurality of holes having a diameter of approximate 0.25 cm. The rolling machine rotates with a speed of 1200 rpm (revolutions per minutes) for removing kernels from the plum jam by eccentric forces applied to the flesh.

Then a mixing process is applied to the flesh of the plum jam without kernels. In this process, the flesh of plum jam without kernels is placed in a horizontal rolling machine with a plurality of holes having a diameter of approximate 0.06 cm. The rolling machine rotates with a speed of 1200 rpm (revolutions per minutes) for making the flesh into a plurality of small pieces which are mixed with air. Then the enzyme, fruit acids in the flesh will fully contact with air so as to leaven for further decomposing the flesh of the plum jam into flesh foam.

Then the flesh foam is placed in a temperature of about 20° C. through 40 hours. During this period, the flesh foam is decomposed naturally. The air in the flesh foam will make the non-decomposed fleshes flow to the upper layer of the flesh foam as a thin plum flesh layer. The fermented plum juicy is deposed at lower side. Thereby the thin plum flesh layer and the plum juicy are separated and can be extracted for condensation individually by following steps:

### (1) Condensation of Thin Plum Flesh Layer and Extraction of Easily Evaporated Minim Nutrition

The thin plum flesh layer is placed in a container which is high pressure and high temperature tolerant under a pressure of 128 PA and temperatures between 95° C. and 120° C. for dewater so as to get thick and black paste like plum material. The paste like plum material has a percentage of 25 vol %˜29 vol % of the original fleshes. One end of a pressure guide (release) tube is installed at an upper side of the container for controlling the pressure therein. Thus, vapor generated in the process will flow out from the guide tube. Another end of the guide tube is connected to a condenser for condensing the vapor into water solution so as to get the minim nutrition in the evaporating process. Then the water is extracted as water solution with plum abstract with the minim nutrition. The product in the container is black paste like plum material which is highly economic.

### (2) Condensation of Plum Juicy and Extraction of Easily Evaporated Minim Nutrition

The plum juicy is placed in a container which is high pressure and high temperature tolerant under a pressure of 128 PA and temperature between 95° C. and 120° C. for condensation. The time period applied in condensation is determined by the degree of condensation. One end of a pressure guide tube is installed at an upper side of the container for controlling the pressure therein. Thus, vapor generated in the process will flow out from the guide tube. Another end of the guide tube is connected to a condenser for condensing the vapor into water solution so as to get the minim nutrition in the evaporating process. Then the water is extracted as water solution with plum abstract with the minim nutrition. The product in the container is plum abstract which is highly economic.

By the method of the present invention, in the processes of condensing thin plum flesh layer and plum juicy, the nutrition can be retained completely. The value of the product can be promoted greatly and sub-product is also extracted.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for fermenting, extracting and condensing nutrition in the flesh of plum jam, comprising the steps of:
a) mixing pre-prepared flesh of plum jam and air fully so as to make the flesh into foam state;
b) fermenting the flesh foam in temperatures between 25° C. to 30° C. through 30 to 52 hours; so the non-decomposed flesh flows at the upper layer of the flesh foam as a thin plum flesh layer; and the fermented plum juicy is flown to and deposed at lower side;
c) extracting the thin plum flesh layer and the plum juicy, which are extracted separately for condensation, individually;
d) placing the thin plum flesh layer in a container under a pressure between 90 PA to 145 PA and temperature between 80° C. and 150° C. for dewater so as to make thick and black paste like plum material which has a weight percentage of 20 vol % to 35 vol %;
e) vapor generated in the process d) flow out from the guide tube to a condenser for condensing the vapor into water solution so as to get the minim nutrition in the evaporating process; then the water is extracted as water solution with plum abstract having the minim nutrition; and the product in the container is black paste like plum material;
f) placing the plum juicy in a container under a pressure between 90 PA to 145 PA and temperature between 80° C. and 150° C. for dewater so as to get plum juicy with less water;
g) vapor generated in the process f) flow out from the guide tube to a condenser for condensing the vapor into water solution so as to get the minim nutrition in the evaporating process; then the water is extracted as water solution with plum juicy having the minim nutrition.
